(19) United States
(12) Patent Application Publication
(10) Pub. No.: US 2026/0303981 A1
(43) Pub. Date: Oct. 1, 2026

(54) METHOD AND SYSTEM FOR DYNAMICALLY ADJUSTING EXPOSURE SETTINGS

(71) Applicant: E-CON SYSTEMS INDIA PRIVATE LIMITED., Chennai (IN)

(72) Inventor: R Vigneshkumar, Chennai (IN)

(21) Appl. No.: 19/089,882

(22) Filed: Mar. 25, 2025

(51) Int. Cl. H04N 23/743; H04N 23/71; H04N 23/72

(52) U.S. Cl. CPC H04N 23/743; H04N 23/71; H04N 23/72

(57) ABSTRACT

A method and system for dynamically adjusting exposure settings of an image frame in an imaging device to obtain a high dynamic range (HDR) image. The method captures an image frame of a scene using the imaging device. The method further divides the image frame into a plurality of sections. The method determines for each section, an exposure value that represents the brightness level of the section. The method further compares the exposure value of each section against a target exposure value. The target exposure value is determined based on at least one of predefined brightness thresholds or user-defined exposure settings. Furthermore, the method dynamically adjusts exposure settings for each section based on the comparison. The exposure settings include at least one of shutter speed, ISO sensitivity and gain. The method merges the exposure adjusted sections to generate the HDR image.

### FIELD OF THE INVENTION

The present disclosure relates to the field of image processing. More particularly, it is related to a system and a method for dynamically adjusting exposure settings.

### BACKGROUND OF THE INVENTION

The following description of related art is intended to provide background information pertaining to the field of the present disclosure. This section may include certain aspects of the art that may be related to various aspects of the present disclosure. However, it should be appreciated that this section be used only to enhance the understanding of the reader with respect to the present disclosure, and therefore, unless otherwise indicated, it should not be assumed that any of the approaches described in this section qualify as prior art merely by virtue of their inclusion in this section.

In image processing, exposure control is required for capturing images with optimal brightness, contrast, and clarity across varying lighting conditions. For example, in outdoor photography, a scene may include bright areas such as the sky and shaded regions like buildings or landscapes. Applying a uniform exposure setting across the entire frame often results in overexposure in bright regions and underexposure in darker areas, leading to a loss of detail at both extremes.

To address this problem in the conventional system, the image frames are divided into fixed sections (for example, upper and lower halves or quadrants) for exposure adjustments, which do not provide the necessary flexibility to effectively handle scenes with intricate lighting. Furthermore, conventional system often relies on manual adjustments or are restricted to pre-defined divisions, making it difficult to capture high-quality images in dynamic or complex lighting environments. However, this approach requires optimal technique or a method for efficient handling of complex lighting scenarios, and exposure control in the image frame.

Therefore, there is a need to find an alternative method to overcome the aforementioned problems.

### SUMMARY OF THE INVENTION

The present invention provides a significant advantage by optimizing exposure in image sensors by introducing a configurable multi-section auto-exposure mechanism. The method divides an image frame into a customizable number of sections which allows each section to undergo independent auto-exposure adjustments.

By enabling customizable exposure control across multiple sections of the image frame, the invention enables improved image quality in scenes with non-uniform lighting conditions, ensuring optimal brightness and contrast across both high-illumination and low-illumination regions. The automated adjustment of exposure settings eliminates the need for manual intervention, thereby ensuring consistent image quality in dynamic and complex lighting environments. Furthermore, the invention simplifies exposure management by automating exposure adjustments across multiple configurable sections, making it adaptable to a wide range of imaging applications.

According to a first aspect of the present disclosure, a system for dynamically adjusting exposure settings of an image frame of a scene in an imaging device to obtain a high dynamic range (HDR) image comprising an image sensor configured to: configure an image sensor and capture an image frame of a scene. A processing unit operably coupled to the image sensor, the processing unit comprises a frame division unit configured to divide the image frame into a plurality of sections within the image sensor. The number and shape of the sections are predefined or configured by a user. An exposure analysis unit configured to determine an exposure value for each section wherein the exposure value represents the brightness level of the section. A control unit configured to compare the exposure value of each section against a target exposure value. The target exposure value is determined based on at least one of predefined brightness thresholds or user-defined exposure settings. An exposure adjusting unit configured to dynamically adjust the exposure settings for each section based on the comparison, wherein the exposure settings include at least one of shutter speed, ISO sensitivity and gain. A HDR generation unit configured to merge the exposure adjusted sections to generate the HDR image.

In some aspects, the sections are arranged in at least one of a grid, strips, or custom-defined sections.

In some aspects, the exposure adjustments are performed continuously in real time during image capture to dynamically accommodate the varying light.

In some aspects, the frame division unit individually monitors the plurality of sections to change the exposure for the specific section where a scene change is detected based on at least one of image parameter variations or predefined image patterns, and prioritizes the exposure adjustments for the specific section in real time.

In some aspects, determining the exposure value and target exposure value for each section comprises applying the image processing techniques including at least one of histogram analysis, luminance computation, and contrast detection.

According to a second aspect of the present disclosure, a method for dynamically adjusting exposure settings of an image frame in an imaging device to obtain a high dynamic range (HDR) image. The method further comprises configuring an image sensor and capturing an image frame of a scene using the imaging device. The method further comprises dividing the image frame into a plurality of sections within the image sensor. The number and shape of the sections are predefined or configured by a user. The method further comprises determining an exposure value for each section that represents the brightness level of the section. The method further comprises comparing the exposure value of each section against a target exposure value. The target exposure value is determined based on at least one of predefined brightness thresholds or user-defined exposure settings. The method further comprises dynamically adjusting the exposure settings for each section based on the comparison. The exposure settings include at least one of shutter speed, ISO sensitivity and gain. The method further comprises merging the exposure adjusted sections to generate the HDR image.

In some aspects, the method comprises the step of dividing the image frame further comprises allowing a user to configure the number and shape of sections, wherein the sections are arranged in at least one of a grid, strips, or custom-defined sections.

In some aspects, the method further comprises exposure adjustments that are performed continuously in real time during image capture to dynamically accommodate the varying light conditions.

In some aspects, the method further comprises individually monitoring the plurality of sections to change the exposure for the specific section where a scene change is detected based on at least one of image parameter variations or predefined image patterns, and prioritizing exposure adjustments for specific section in real time

In some aspects, the method further comprises determining the exposure value and target exposure value for each section comprises applying image processing techniques, including at least one of histogram analysis, luminance computation, and contrast detection.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF ACCOMPANYING DRAWINGS

The above aspects, features and advantages of the disclosed technology, will be more fully appreciated by reference to the following illustrative and non-limiting detailed description of example embodiments of the present disclosure, when taken in conjunction with the accompanying drawings, in which:

FIG. 1 illustrates a block diagram of a system for dynamically adjusting exposure settings of an image frame in an imaging device to obtain a high dynamic range (HDR) image, according to an embodiment of the invention;

FIG. 2 illustrates a block diagram of a processing unit for the system, according to an embodiment of the invention;

FIG. 3 illustrates a flow chart of a method for dynamically adjusting exposure settings of an image frame in an imaging device to obtain a high dynamic range (HDR) image, according to an embodiment of the invention; and

FIGS. 4A-4C illustrate the generation of the final HDR image from a captured image frame of the scene, in accordance with an exemplary embodiment of the invention.

### DETAILED DESCRIPTION OF THE PREFERRED EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

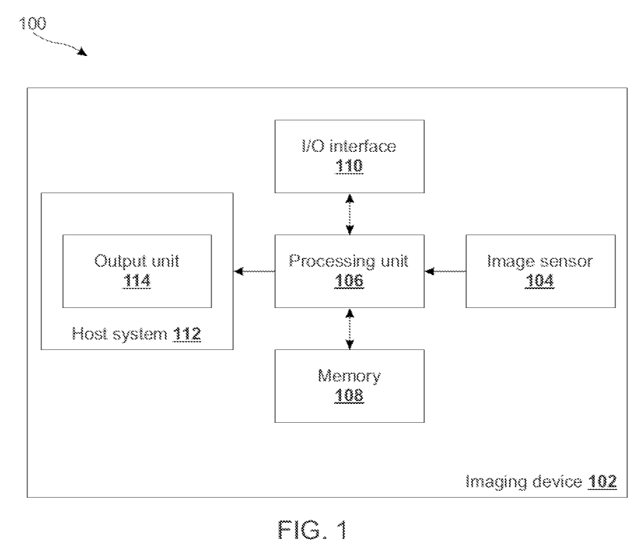

FIG. 1 illustrates a block diagram of a system 100 for dynamically adjusting exposure settings of an image frame in an imaging device 102 to obtain a high dynamic range (HDR) image, according to an embodiment of the invention.

The system 100 is configured to capture the image frame of a scene. In certain embodiments, the system 100 may receive the image frame from one or more sources, such as various social media applications, Bluetooth, or any other wireless or non-wireless communication mechanism. Further, the system 100 divides the image frame into a plurality of sections, with the number and shape of the sections are predefined or being configurable by a user. Additionally, the system 100 may individually monitor the plurality of sections to change the exposure for the specific section where a scene change is detected. The system 100 further determines an exposure value for each section that represents the brightness level of that section. The exposure value for each section is compared against a target exposure value, which is determined based on predefined brightness thresholds or user-defined exposure settings. Based on the comparison, the system 100 dynamically adjusts the exposure settings for each section, with the exposure settings including, but not limited to, shutter speed, ISO sensitivity, and gain. Finally, the system 100 merges the exposure-adjusted sections to generate an HDR image.

As disclosed in FIG. 1, the system 100 comprises the imaging device 102. The imaging device 102, include an electronic device, such as a mobile or stationary telephone handset (e.g., a smartphone, cellular telephone, or the like), a desktop computer, a laptop or notebook computer, a tablet computer, a set-top box, a television, a camera, a display device, a digital media player, a video gaming console, a video streaming device, or any other suitable electronic device. In another embodiment, the imaging device 102 may further include one or more wireless transceivers configured for wireless communication.

The imaging device 102 further comprises an image sensor 104, a processing unit 106, a memory 108, an Input/Output (I/O) interface 110, and a host system 112.

The image sensor 104 captures image frames by converting incoming light into electrical signals. The electrical signals are subsequently processed to form a digital representation of the scene. The image sensor 104 is configured to sense the intensity of light across its pixel array, with each pixel detecting the amount of light corresponding to a specific part of the scene. The image sensor 104 collects data from the entire scene and generates the image frame.

Examples of the one or more image sensors 104 of the imaging device 102 may include but not limited to, a stationary camera, a Pan-Tilt-Zoom (PTZ) camera, and the like. The image sensor 104 may be a hybrid CCD/CMOS sensor (such as sCMOS), an N-type metal-oxide semiconductor (NMOS), an electron-multiplying CCD (EMCCD) sensor, an active-pixel sensor (APS), a complementary metal-oxide semiconductor (CMOS), or another combination thereof.

Aspects of the present disclosure are intended to include or otherwise cover any type of image sensor 104 including known, related art, and/or later developed camera sensors. These image sensors 104 interface with various components of the imaging device 102 to facilitate image processing and enhancements.

As disclosed in FIG. 1, one such component is the processing unit 106, which is operably coupled to the image sensor 104 through the I/O interface 110.

The processing unit 106 may be configured to perform at least one image processing operation on the plurality of image frames that are being received or captured from the image sensor 104. The processing unit 106 may include suitable logic, instructions, circuitry, interfaces, and/or codes for executing various operations, such as the operations associated with the user device, and/or the like. In some aspects of the present disclosure, the processing unit 106 may utilize one or more processors such as Arduino or raspberry pi or the like. Further, the processing unit 106 may be configured to control one or more operations executed by the imaging device 102 in response to the input received at the user interface from the user. Examples of the processing unit 106 may include, but are not limited to, an application-specific integrated circuit (ASIC) processor, a reduced instruction set computing (RISC) processor, a complex instruction set computing (CISC) processor, a field- programmable gate array (FPGA), a Programmable Logic Control unit (PLC), and the like. Aspects of the present disclosure are intended to include or otherwise cover any type of the processing unit 112 including known, related art, and/or later developed processing units.

The processing unit 106 is operably coupled to the memory 108. The memory 108 may be configured to store the logic, instructions, circuitry, interfaces, and/or codes of the processing unit 106, data associated with the system 100. In some aspects of the present disclosure, the memory 108 may be configured to store a variety of inputs received from the user. Examples of the memory 108 may include, but are not limited to, a Read-Only Memory (ROM), a Random-Access Memory (RAM), a flash memory, a removable storage drive, a hard disk drive (HDD), a solid-state memory, a magnetic storage drive, a Programmable Read Only Memory (PROM), an Erasable PROM (EPROM), and/or an Electrically EPROM (EEPROM). Aspects of the present disclosure are intended to include or otherwise cover any type of memory 108 including known, related art, and/or later developed memories.

As disclosed in FIG. 1, the processing unit 106 is communicatively coupled to one or more I/O interfaces 110. The I/O interface(s) 110 may include any combination of hardware, firmware, and/or software configured to receive user input and provide user output. One or more I/O interfaces 110 may be employed to receive input associated with a single virtual experience. I/O interface 110 may comprise any suitable hardware, firmware, software, or a combination thereof that supports input and output functionality. By way of example, I/O interface 110 may include hardware and/or software components for capturing user input, including but not limited to a keyboard or keypad, a touchscreen component (e.g., touchscreen display), a receiver (e.g., a Radio Frequency (RF) or infrared receiver), motion sensors, and/or one or more input buttons.

In some embodiments, the I/O interfaces 110 may include one or more devices configured to present output to a user, including, but not limited to, a graphics engine, a display (e.g., a display screen), one or more output drivers (e.g., display drivers), one or more audio speakers, and one or more audio drivers. In certain embodiments, the I/O interface 110 is configured to provide graphical data to a display for presentation to the user. The graphical data may represent one or more graphical user interfaces and/or any other graphical content, as required by a particular implementation.

As disclosed in FIG. 1, the processing unit 106 is communicatively connected to the host system 112. The host system 112 may be configured to identify the generated HDR image and originating from the image sensor 104. For example, the host system 112 may include various portable/non-portable computing devices such as a monitor, a laptop computer, a desktop computer, a notebook, a smart phone, a tablet, a phablet, or similar devices. Furthermore, the host system 112 comprises an output unit 114 and is configured to display the generated HDR image.

The output unit 114 may be any suitable display or screen configured to allow user interaction and/or to present items, such as captured video or images, for viewing by the user. In certain embodiments, the output unit 114 may be a touch-sensitive display. In other examples, the output unit 114 may be an interface configured to present the generated HDR image, including but not limited to, a liquid crystal display (LCD), an organic light-emitting diode (OLED) display, an electronic viewfinder, a projection system, or any other visual output device capable of rendering the generated HDR image.

The output unit 114 and/or the I/O interfaces 110 may be configured to provide output, such as image data, to the user and/or receive user input for adjusting one or more settings of the camera 502, including but not limited to, configuring the number and shape of sections of the image frame.

While some examples of user inputs are provided, other user inputs may exist, and the present disclosure should not be limited to the provided examples.

In an exemplary aspect of the present disclosure, the system 100 may include the power supply. The power supply may be coupled to various components of the imaging device 102 (i.e., the processing unit 106, the memory 108, the I/O interface 110, and the host system 112) and may be configured to provide electrical energy to the various components of the imaging device 102.

In some embodiments, the system 100 may be utilized in a variety of applications, including, but not limited to, medical imaging for diagnostic and therapeutic purposes, traffic monitoring for vehicle detection and analysis, industrial applications such as quality control, inspection, and automation, as well as outdoor photography, which may include surveillance, landscape imaging, and environmental monitoring. The system 100 is configured to operate under diverse lighting conditions and environmental settings and is adaptable to various imaging modalities, thereby enhancing its applicability across a broad spectrum of use cases.

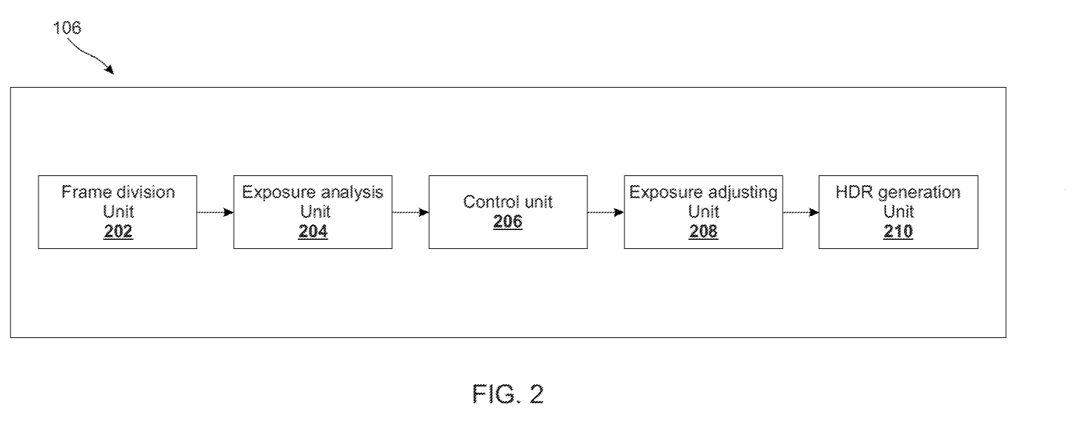

FIG. 2 illustrates a block diagram of a processing unit 106 for the system 100, according to an embodiment of the invention.

As disclosed in FIG. 1, the processing unit 106 comprises a frame division unit 202, an exposure analysis unit 204, a control unit 206, an exposure adjusting unit 208, and a HDR generation unit 210.

The processing unit 106 is configured to operate as a pipeline, wherein each unit (including the frame division unit 202, the control unit 206, exposure analysis unit 204, exposure adjusting unit 208, and HDR generation unit 210) processes image data sequentially and transmits the processed data to the subsequent unit. The interconnection of each unit (i.e., frame division unit 202, control unit 206, exposure analysis unit 204, exposure adjusting unit 208, and HDR generation unit 210) ensures that exposure adjustments are applied in real-time in a structured and systematic manner, thereby enabling the generation of an optimized HDR image with enhanced dynamic range and improved visibility. The various examples of processing unit are described in detail in conjunction with FIG. 1.

The frame division unit 202 is configured to divide the image frame into a plurality of sections. The frame division unit 202 enables user configuration of both the number and shape of the sections. In some embodiments, the division of the image frame may be performed using various techniques, including but not limited to, grid-based segmentation, strip-based segmentation, or custom-defined section partitioning. For example, the user may configure the division or segmentation of the image frame through the I/O interface 110 as described in FIG. 1. The user may specify both the number and shape of the sections based on the requirements for exposure variations. Each section of the plurality of sections is associated with different exposure settings across the image frame.

In an example, the division of the image frame may be either user-defined or automatically determined based on scene analysis. Further, the user may configure the division of the image frame by specifying both the number and shape of the sections through the I/O interface 110. The user input may include, but is not limited to, interactions with a touch-sensitive display, cursor control, audible commands, device movement, gaze detection, or a combination thereof. The user input is not restricted to a single action and may involve multiple interactions, such as single or multiple touches, voice commands, or gestures. For instance, the user may interact with one or more portions of the image or select options displayed on a touch-sensitive display. The options may include a graphical representation of a grid, a predefined sectioning pattern, a custom shape selection tool, or an interactive menu enabling the user to specify the number and shape of the sections.

By dividing the image frame into the plurality of sections, the frame division unit 202 enables precise evaluation of brightness levels, thereby enhancing overall image quality and dynamic range. Accordingly, the frame division unit 202 is configured to provide user-configurable settings, ensuring adaptability across various imaging scenarios. The plurality of sections may be arranged in predefined patterns, including but not limited to grids, strips, or custom-defined sections.

The frame division unit 202 may be configured to monitor the plurality of sections individually to change the specific section where a scene change is detected based on at least one of image parameter variations and predefined image patterns. In some embodiments, the plurality of sections may be monitored individually by analyzing the image frame to identify sections exhibiting significant variations in parameters such as brightness, contrast, edge density, or color distribution. Additionally, the detection of the scene change may incorporate predefined image patterns, including but not limited to facial recognition templates, motion detection algorithms, or scene classification techniques, to further enhance the identification of the specific section.

Upon detecting the scene change, the frame division unit 202 is configured to prioritize exposure adjustments in the specific section where such adjustments are required, thereby optimizing the distribution of exposure across the plurality of sections. By prioritizing the exposure adjustments for the specific section, the processing unit 106 ensures that critical visual information within the image frame is accurately captured, preventing overexposure or underexposure while maintaining an overall exposure balance. The detection of scene changes and the prioritization of exposure adjustments for the specific section may be facilitated by employing image processing techniques, including machine learning-based models, edge detection filters, contrast enhancement algorithms, and histogram-based luminance analysis. The implementation of these techniques enables real-time, adaptive specific section detection and exposure adjustment, even in dynamically changing scenes.

By monitoring the plurality of sections, detecting the scene change, and prioritizing exposure adjustments, the processing unit 106 enables the capture of the HDR images with enhanced detail, improved contrast, and increased accuracy under varying lighting conditions. The exposure adjustments may be particularly advantageous in applications such as medical imaging, surveillance, automotive vision systems, and professional photography, where precise exposure control is essential for high-quality image acquisition.

In an exemplary embodiment, the processing unit 106 may further allow user-defined configuration of parameters of the specific section, including but not limited to sensitivity levels for detecting variations in image parameters or the selection of specific predefined patterns for specific section. Additionally, prioritization of exposure adjustments for the specific section may be performed using dynamic weighting mechanisms, wherein weight values are assigned to different sections of the image frame based on their relative importance.

After the image frame is divided according to a user-defined configuration and the detection of the specific section, the exposure analysis unit 204 is configured to analyze the exposure value of the image frame. The exposure value of each section corresponds to the brightness level within the plurality of sections. The exposure analysis unit 204 may employ various image processing techniques, including but not limited to, histogram analysis, luminance computation, and contrast detection.

In some embodiments, the exposure value and target exposure value for each section are analyzed using various image processing techniques such as histogram analysis, luminance computation, and contrast detection, which accurately assess the light intensity of each section to ensure optimal exposure adjustments. Using these techniques, the exposure analysis unit 204 is configured to analyze the exposure value and target exposure value for each section of the image frame. Thus, by analyzing the brightness levels within the plurality of sections, the exposure analysis unit 204 ensures precise exposure assessment of the image frame. The exposure analysis unit 204 may subsequently transmit the analyzed exposure values to the control unit 206 for further processing.

Upon receiving the exposure values for the plurality of sections from the exposure analysis unit 204, the control unit 206 may be configured to compare the exposure value against a predefined target exposure value. In an example, the predefined target exposure value may be either set by the user or determined based on predetermined brightness thresholds. The comparison of the exposure values against the target exposure value enables the system 100 to identify underexposed or overexposed sections within the image frame. By performing the comparison, the control unit 206 determines whether the analyzed exposure values match the target value. In the event of a mismatch between the analyzed exposure values and the target value, the control unit 206 may transmit instructions to the exposure adjusting unit 208 to dynamically adjust the exposure settings.

The exposure adjusting unit 208 is configured to dynamically adjust the exposure settings of each section of the plurality of sections. The exposure settings that may be adjusted include shutter speed, ISO sensitivity, gain, and the like, for each of the plurality of sections. Furthermore, each section of the plurality of sections may undergo independent exposure adjustment, which may be performed using techniques such as histogram equalization, tone mapping, or other exposure optimization algorithms. The exposure adjustments are configured to preserve image detail and contrast while minimizing noise and preventing overexposure.

By dynamically adjusting the exposure settings, the exposure adjusting unit 208 ensures that each section of the image frame achieves an optimal brightness level, thereby preventing overexposed highlights and underexposed shadows. Furthermore, the exposure adjusting unit 208 enables precise adaptation to varying lighting conditions, thereby improving the overall image quality.

Upon the adjustment of the exposure settings by the exposure adjusting unit 208, the HDR generation unit 210 is configured to process the plurality of sections to generate the HDR image. The HDR generation unit 210 ensures that details from both the darkest and brightest sections of the scene are preserved without introducing overexposure or underexposure. Furthermore, the HDR generation unit 210 is configured to merge the individually adjusted sections of the image frame to form a final image or HDR image (both terms are used interchangeably throughout this application).

In an exemplary aspect of the present disclosure, a Weighted Averaging with Smooth Transition Blending technique is employed to merge multiple exposure-adjusted sections of the image.

A weight map may be generated for each divided or segmented image section based on local exposure characteristics, scene content, and the relative significance of each section in contributing to the final image. In some embodiments, the weight map may define the proportional influence of the pixel values within each section on the final image. Various weighting functions may be utilized, including but not limited to Gaussian distributions, sigmoid functions, or other adaptive techniques that consider local contrast variations and scene content.

A Gaussian blurring technique may be applied to the weight maps to mitigate abrupt transitions between the plurality of image sections. In one example, the Gaussian blurring technique may involve convolving each weight map with a Gaussian kernel, which diffuses the weight values and facilitates gradual intensity variations across the boundaries of the plurality of sections. The kernel size and standard deviation of the Gaussian function may be determined based on at least one of the image resolution and the desired level of blending smoothness. The Gaussian smoothing technique may reduce hard edges and visible seams that may otherwise result from differences in exposure settings between the plurality of sections. Accordingly, the Gaussian blurring technique enables seamless weight transitions, thereby producing a visually consistent blend while preserving the integrity of the original scene. Additionally, the Gaussian blurring technique may prevent image artifacts, including but not limited to halos, ghosting effects, or noise.

While some examples of artifacts are provided, other artifacts may exist, and the present disclosure should not be limited to the provided examples.

In some examples, pixel intensities for each section of the plurality of sections are combined using a weighted summation approach. Accordingly, the weighted averaging of pixel values is determined based on predefined or dynamically computed weighting factors.

Upon determining the weighted averaging of pixel values, computed pixel values are normalized to maintain consistent brightness levels and mitigate unwanted intensity variations. The normalization of computed pixel values ensures that the sum of weight values at each pixel location is equal to one, thereby preventing excessive brightening or dimming of specific sections within the image.

By normalizing the computed pixel values, the image is processed to preserve the exposure adjustments, thereby maintaining uniformity in brightness and contrast levels across the image frame.

Upon normalization of the pixel values, the HDR image is generated by integrating the exposure-adjusted sections based on computed weighted averages. The generated HDR image enables a seamless transition between different exposure levels, ensuring that all regions maintain optimal brightness while minimizing artifacts. Additionally, the HDR image is configured to enhance detail retention in both highlight and shadow regions, thereby achieving a balanced representation of the scene’s dynamic range.

In an embodiment, the system 100 is configured to determine the number of images to be captured for generating the HDR image. Additionally, the system 100 may determine the exposure value to be applied for each of the captured images. The number of images to be captured may be based on the number of the specific section identified within the image, where the specific section may be determined based on user input, facial recognition operations performed on the scene, the center portion (or region) of the preview image, other aspects of the preview image, or any combination thereof.

The processing unit 106 is configured to continuously execute exposure adjustments in real time during the image capture process to dynamically respond to variations in ambient lighting conditions. The processing unit 106 monitors the scene and adjusts exposure parameters, including but not limited to shutter speed, aperture, and ISO sensitivity, based on detected changes in lighting. The real-time adjustment of the exposure parameters enables the system 100 to compensate for fluctuations in ambient light, including natural variations such as shifting sunlight and moving clouds, as well as artificial variations such as flickering indoor lighting. Therefore, the system 100 may prevent overexposure in high-intensity lighting conditions and underexposure in low-light environments, thereby improving image quality. Additionally, the system 100 facilitates seamless transitions in exposure levels, particularly in scenarios involving rapid motion, where lighting conditions may vary between successive frames.

The described technique is applicable to various imaging applications, including, but not limited to, video recording, surveillance, and automated photography, where maintaining consistent brightness and detail is critical. Furthermore, the system 100 may be integrated with advanced computational techniques, such as artificial intelligence-based scene analysis and the like, to optimize exposure settings based on detected subjects, background illumination, and other contextual parameters. By automatically adapting to changing lighting conditions without requiring user intervention, the method enhances the operational efficiency and reliability of the system 100, thereby ensuring high-quality visual output across diverse environments.

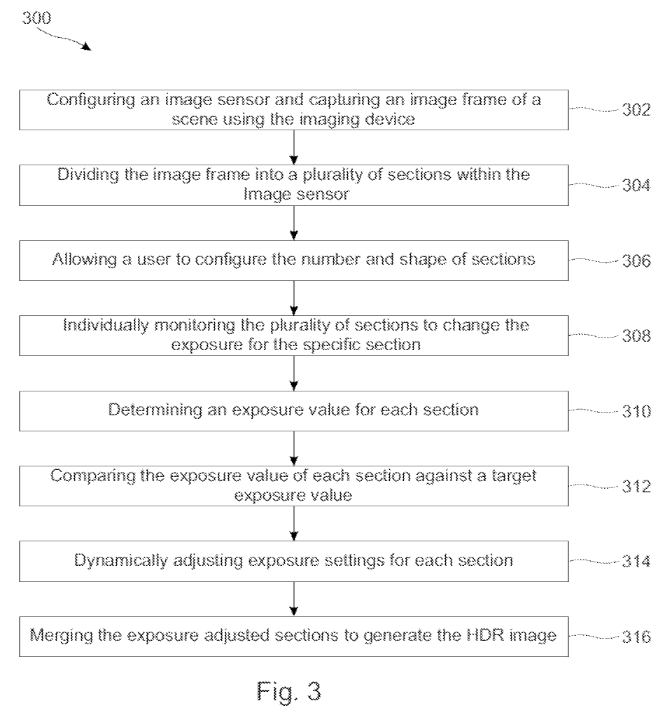

FIG. 3 illustrates a flow chart of a method 300 for dynamically adjusting exposure settings of the image frame in the imaging device 102 to obtain a HDR image, according to an embodiment of the invention.

At step 302, the method 300 comprises configuring an image sensor and capturing an image frame of the scene using the imaging device 102.

In some aspects of the present disclosure, the system 100 may may configure the image sensor and capture the image frame of the scene using the imaging device 104. Furthermore, the image sensor 104 referred in the FIG. 1, may captures image frames of the scene. The image sensor 104 is described in detail in conjunction with FIG. 2.

In some examples, the system 100 may receive image frame of the scene from one or more sources. The sources may be various social media applications, or via Bluetooth, or any other wireless or non-wireless mechanism. social media application, and/or the like.

At step 304, the method 300 comprises dividing the image frame into a plurality of sections within the image sensor.

In some aspects of the present disclosure, to divide the image frame into the plurality of sections, the system 100 may divide the image frame into the plurality of sections within the image sensor using the frame division unit 202. The frame division unit 202 is described in detail in conjunction with FIG. 2. Furthermore, the frame division unit 202 may divide the image frame into the plurality of sections. In some examples, the number and shape of the sections are predefined or configured by the user.

At step 306, the method 300 comprises allowing a user to configure the number and shape of sections.

In some aspects of the present disclosure, to allow the user to configure the number and shape of sections, the system 100 may receive the user input through the Input/Output (I/O) interface 110. In some examples, I/O interface 110 may include hardware and/or software for capturing user input. The user input includes a keyboard or keypad, a touchscreen component (e.g., touchscreen display), a receiver (e.g., RF or infrared receiver), motion sensors, one or more input buttons, and/or the like.

In some examples, the sections are arranged in at least one of a grid, strips, or custom-defined sections.

At step 308, the method 300 comprises individually monitoring the plurality of sections to change the exposure for the specific section.

In some aspects of the present disclosure, to individually monitor the plurality of sections, the system 100 may individually monitor the plurality of sections to change the exposure for the specific section using the frame division unit 202. The exposure for the specific section is changed upon detection of the scene change corresponding to specific section. The frame division unit 202 is described in detail in conjunction with FIG. 2.

In some examples, the monitoring of the plurality of sections to change the exposure for the specific section is done based on at least one of image parameter variations or predefined image patterns, and prioritizing exposure adjustments for specific section in real time.

At step 310, the method 300 comprises determining, for each section, an exposure value.

In some aspects of the present disclosure, to determine the exposure value for each section, the system 100 may analyze the exposure value using the exposure analysis unit 204. Furthermore, the exposure analysis unit 204 may analyze the exposure value for each section of the image frame. The exposure value represents the brightness level of the section. The exposure analysis unit 204 is described in detail in conjunction with FIG. 2.

In some examples, the exposure analysis unit 204 may analyze the exposure value using various techniques such as histogram analysis, luminance computation, or contrast detection.

At step 312, the method 300 comprises comparing the exposure value of each section against a target exposure value.

In some aspects of the present disclosure, to compare the exposure value of each section against the target exposure value, the system 100 may compare the exposure value of each section of the image frame against the target exposure value using the control unit 206. Furthermore, the control unit 206 may compare the exposure value of each section of the image frame against the target exposure value. The control unit 206 evaluates whether the analyzed exposure values match the predefined value or not. The control unit 206 is described in detail in conjunction with FIG. 2.

In some examples, the target exposure value is value is determined based on at least one of predefined brightness thresholds or user-defined exposure settings.

At step 314, the method 300 dynamically adjusting, exposure settings for each section.

In some aspects of the present disclosure, to dynamically adjust exposure settings for each section based on the comparison, the system 100 may dynamically adjust exposure settings for each section using the exposure adjusting unit 208. After comparing the exposure values against the predefined target exposure value, the control unit 206 may send the instructions to the exposure adjusting unit 208 based on the comparison of the analyzed exposure value with the predefined value. In the case of mismatch between the analyzed exposure value with the predefined value, the exposure adjusting unit may dynamically adjust the exposure settings of each section of the plurality of sections. The exposure adjusting unit 208 is described in detail in conjunction with FIG. 2.

In some examples, the exposure settings include at least one of shutter speed, ISO sensitivity and gain.

At step 316, the method 300 comprises merging the exposure adjusted sections to generate the HDR image.

In some aspects of the present disclosure, to merge the exposure adjusted sections to generate the HDR image, the system 100 may merge the exposure adjusted sections to generate the HDR image using the HDR generation unit 210. Furthermore, the HDR generation unit 210 may merge the plurality of the sections of the image frame to generate the final image. After dynamically adjusting the exposure settings for each section, the HDR generation unit 210 may merge the plurality of the sections of the image frame. Furthermore, the HDR generation unit 210 may process the plurality of the sections to form the final image. The HDR generation unit 210 is described in detail in conjunction with FIG. 2.

The present invention provides a technical advantage by enabling dynamic and section wise exposure adjustments to optimize image quality in varying lighting conditions. Further, the present invention enables the configuration of the number and shape of the sections by the user. Furthermore, the present invention seamlessly merges exposure-adjusted sections to generate the HDR image.

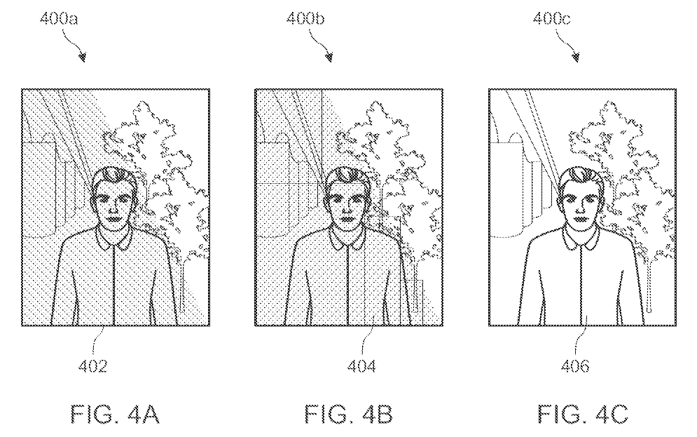

FIGS. 4A-4C illustrate the generation of the final HDR image 406 from a captured image frame 402 of the scene, in accordance with an exemplary embodiment of the invention.

Referring to FIG. 4A, the image sensor 104 captures an underexposed image 400A of the scene. The underexposed image 400A is characterized by low brightness levels. In some embodiments, while the operations described with respect to FIGS. 4A and 4B are associated with the imaging device 102, such operations may be performed by the imaging device 102. In the context of FIGS. 4A and 4B, the imaging device 102 may include a touchscreen or another type of display screen configured to present a preview of the captured image frame 402. For example, if the imaging device 102 comprises a camera or a mobile phone, the screen may display one or more previews of the captured image frames 402 before a user actuates a shutter button.

FIG. 4B illustrates a preview of the captured image frame 402 (hereinafter referred to as 400B), which depicts a scene that includes a human subject whose face appears underexposed. The scene comprises an environmental background, including a flyover structure positioned adjacent to the right-hand side of the subject. The flyover illuminates the left-hand side of the scene, while the right-hand side remains relatively dimly lit and shadowed. Consequently, in the captured image frame 402, the subject’s facial region appears dimly lit and shadowed due to insufficient environmental illumination. In contrast, in the final HDR image 406 as shown in FIG. 4C, the subject’s face is well illuminated and free from shadows due to enhanced exposure processing.

FIG. 4B further illustrates a preview frame 404 of FIG. 4A, wherein multiple sections of the image are predefined or identified by the user. In this embodiment, the preview of the captured image frame 402 corresponds to the same scene as in FIG. 4A, but with some sections selected by the user. The sections selected by the user can vary in shape and size. The user may select the sections within the captured image frame 402, such as the subject’s face and clothing. In some embodiments, the sections may be designated by some shapes around the face and another around the clothing.

In an exemplary scenario, the preview of the captured image frame 402 may be displayed on a touchscreen or another display of the imaging device 102. The user may interact with the screen by selecting the subject’s face or environmental elements within the scene. In response, the imaging device 102 identifies sections that include the subject’s face and background. In some embodiments, an object recognition algorithm may be employed to determine the object selected based on user input, identifying object boundaries and determining an optimal shape and size for the selected section.

The selected sections in the captured image frame 402, as illustrated in FIG. 4B, are represented as shapes. However, such sections may assume various geometrical configurations, including but not limited to square, rectangular, circular, oval, polygonal, or freehand-drawn shapes. In some embodiments, the user may define the shape of a section via input gestures such as drawing with a stylus or a finger on a touchscreen or using a mouse pointer on a graphical interface. A touch, drag, and release action or a click, drag, and release action may define the boundaries of a section, such as specifying two opposite corners of a rectangle or determining a radius or diameter of a circular or oval section.

In some examples, the user may define the sections based on the spatial distribution of objects within the scene, lighting conditions, object boundaries, or areas of interest that require independent exposure adjustments.

Upon identifying the sections in the captured image frame 402, the imaging device 102 determines distinct exposure settings corresponding to each section. The imaging device 102 may achieve this by performing an automatic exposure adjustment process tailored to each section. Specifically, the imaging device 102 may execute an auto-exposure process for pixels within the subject’s face and a separate auto-exposure process for the background environment. Based on the computed exposure settings, the imaging device 102 generates the final HDR image 406, as illustrated in FIG. 4C. The exposure settings are optimized to enhance visibility and contrast within each identified section, thereby improving the clarity and detail of the final HDR image.

The present invention enables section-specific exposure optimization, ensuring that multiple areas within the scene, such as the subject’s face and background, are optimally exposed in the HDR image. Unlike conventional HDR methods that rely on globally applied exposure settings, this approach dynamically adjusts exposure per user-identified sections using automated object recognition and adaptive exposure processing. This results in improved image clarity, enhanced contrast, and reduced loss of detail in both bright and shadowed sections, leading to superior visual quality in varying lighting conditions.

Although the present invention has been described in considerable detail with reference to certain preferred embodiments and examples thereof, other embodiments and equivalents are possible. Even though numerous characteristics and advantages of the present invention have been set forth in the foregoing description, together with functional and procedural details, the disclosure is illustrative only, and changes may be made in detail, especially in terms of the procedural steps within the principles of the invention to the full extent indicated by the broad general meaning of the terms. Thus, various modifications are possible of the presently disclosed system and process without deviating from the intended scope of the present invention.

What is claimed is:

1. A method for dynamically adjusting exposure settings of an image frame in an imaging device to obtain a high dynamic range (HDR) image, comprising:
configuring an image sensor and capturing an image frame of a scene using the imaging device;
dividing the image frame into a plurality of sections within the image sensor, wherein the number and shape of the sections are predefined or configured by a user;
determining, for each section, an exposure value that represents the brightness level of the section;
comparing the exposure value of each section against a target exposure value, wherein the target exposure value is determined based on at least one of predefined brightness thresholds or user-defined exposure settings;
dynamically adjusting exposure settings for each section based on the comparison, wherein the exposure settings include at least one of shutter speed, ISO sensitivity, and gain; and
merging the exposure adjusted sections to generate the HDR image.

2. The method of claim 1, wherein the step of dividing the image frame comprises:
allowing a user to configure the number and shape of sections, wherein the sections are arranged in at least one of a grid, strips, or custom-defined sections.

3. The method of claim 1, wherein the exposure adjustments are performed continuously in real time during image capture to dynamically accommodate the varying light conditions.

4. The method of claim 1, further comprising:
individually monitoring the plurality of sections to change the exposure for the specific section where a scene change is detected based on at least one of image parameter variations or predefined image patterns, and prioritizing exposure adjustments for specific section in real time.

5. The method of claim 1, wherein determining the exposure value and target exposure value for each section comprises applying image processing techniques, including at least one of histogram analysis, luminance computation, and contrast detection.

6. A system for dynamically adjusting exposure settings of an image frame of a scene in an imaging device to obtain a high dynamic range (HDR) image, the system comprising:
an image sensor configured to capture an image frame of a scene;
a processing unit, operably coupled to the image sensor, wherein the processing unit comprises:
a frame division unit configured to divide the image frame into a plurality of sections within the image sensor, wherein the number and shape of the sections are predefined or configured by a user;
an exposure analysis unit configured to determine an exposure value for each section wherein the exposure value represents the brightness level of the section;
a control unit configured to compare the exposure value of each section against a target exposure value, wherein the target exposure value is determined based on at least one of predefined brightness thresholds or user-defined exposure settings;
an exposure adjusting unit configured to dynamically adjust the exposure settings for each section based on the comparison, wherein the exposure settings include at least one of shutter speed, ISO sensitivity, and gain; and
a HDR generation unit configured to merge the exposure adjusted sections to generate the HDR image.

7. The system of claim 6, wherein the sections are arranged in at least one of a grid, strips, or custom-defined sections.

8. The system of claim 6, wherein the exposure adjustments are performed continuously in real time during image capture to dynamically accommodate the varying light conditions.

9. The system of claim 6, wherein the frame division unit is configured to individually monitor the plurality of sections to change the exposure for the specific section where a scene change is detected based on at least one of image parameter variations or predefined image patterns, and prioritizes the exposure adjustments for the specific section in real time.

10. The system of claim 6, wherein determining the exposure value and target exposure value for each section comprises applying the image processing techniques including at least one of histogram analysis, luminance computation, and contrast detection.

11. A non-transitory computer-readable storage medium storing instructions that, when executed by one or more processors of an imaging device, cause the imaging device to perform a method for dynamically adjusting exposure settings of an image frame to obtain a high dynamic range (HDR) image, the method comprising:
configuring an image sensor and capturing an image frame of a scene using the imaging device;
dividing the image frame into a plurality of sections within the image sensor, wherein the number and shape of the sections are predefined or configured by a user;
determining, for each section, an exposure value representing the brightness level of the section;
comparing the exposure value of each section against a target exposure value, wherein the target exposure value is determined based on at least one of predefined brightness thresholds or user-defined exposure settings;
dynamically adjusting exposure settings for each section based on the comparison, wherein the exposure settings include at least one of shutter speed, ISO sensitivity, and gain; and
merging the exposure-adjusted sections to generate the HDR image.
